(19) United States
(12) Patent Application Publication
(10) Pub. No.: US 2022/0364857 A1
(43) Pub. Date: Nov. 17, 2022

(54) SYSTEMS AND METHODS FOR PROVIDING A READING FROM A RANGEFINDING DEVICE

(71) Applicant: Sheltered Wings, Inc. d/b/a Vortex Optics, Barneveld, WI (US)

(72) Inventors: Rob Morell, Barneveld, WI (US); Richard Campbell, Barneveld, WI (US)

(21) Appl. No.: 17/743,131

(22) Filed: May 12, 2022

Related U.S. Application Data
(60) Provisional application No. 63/187,649, filed on May 12, 2021.

(51) Int. Cl. G01C 3/06; G01S 17/08

(52) U.S. Cl. CPC G01C 3/06; G01S 17/08

(57) ABSTRACT

The disclosure relates generally to systems and methods for providing a range from a laser range finding device. In one embodiment, the disclosure relates to systems and methods for providing a consistent ranged distance to a user of a laser range finding device.

### CROSS-REFERENCE TO RELATED APPLICATIONS

This application is a non-provisional patent application of and claims priority to U.S. Provisional Patent Application No. 63/187,649 filed May 12, 2021, which is incorporated herein by reference in its entirety.

### FIELD

The disclosure relates generally to systems and methods for providing a range from a range finding device. In one embodiment, the disclosure relates to systems and methods for determining a consistent range to a user of a range finding device when more than one range, such as a second range, is determined, provided the second range is within acceptable tolerance limits of a first range.

### BACKGROUND

Rangefinders have become an invaluable asset to hunters, golfers, and outdoor enthusiasts. Rangefinders are used widely to assist users in determining the distance to animals, trees, targets, and fairways on a golf course. By obtaining the distance to intended objects, a user can adjust their equipment or position to take full advantage of the distance knowledge. This knowledge is particularly useful to, but not limited to, hunters, shooters, archers, and golfers.

Rangefinders have varying levels of accuracy and displayed distance resolution. A very common rangefinder has a ±1 yard accuracy and a 1-yard display resolution tolerance at distances of less than or equal to 100 yards. This means that a user can expect any distance obtained and displayed by this rangefinder to be within 1 yard of the actual distance of an object within 100 yards of the user. Typically, the accuracy tolerance will expand as the distance between the ranged target and the user increases.

The following is an non-limiting example of how the distance to an object is obtained, processed, and displayed. A user aims their rangefinder at an object and initiates a distance measurement. The device determines the distance to the object, by way of example, the distance is determined to be 51.2 yards. The onboard computer will round this to 51 yards and that will be displayed to the user. The actual distance to the object was 50.8 yards and therefore, the determined distance falls within the ±1 yard accuracy tolerance.

It is possible that if multiple distances are measured to an intended target, different distances may be displayed to the user. There are many causes for this phenomena and the following are just a few, non-limiting, non-exhaustive reasons:
Distance Accuracy of the rangefinder;
Display resolution of the rangefinder;
Rounding algorithm of the rangefinder;
Environmental factors affecting the rangefinders emission and return signal;
The movement of the user during the distance measurement;
The medium used by the rangefinder; and
The proximity of the object to other objects.

While the varying distances displayed to the user are very small and most likely will not result in a missed opportunity on their own, it does instill with the user a level of doubt. There are many factors that go into the preparation for a golf, archery, or rifle shot and the distance to the object is just one of many variables. If the user receives multiple distances to the same target, it may make the user second guess their preparation resulting in a missed shot.

By way of example, and not to limit the disclosure, a golfer is attempting to take a shot at the green. The golfer uses their rangefinder to obtain multiple distances to the pin. The rangefinder returns three distances, 124, 125, and 123 yards. The multiple distances provide a level of doubt to the golfer and causes them to focus more on the distance than on their swing. Due to the extra doubt the multiple distance readings instilled in the user, the golfer's focus is off so that they do not strike the golf ball well and end up missing the green entirely. This was not caused by an improper shot due to the distance ranged but rather the uncertainty caused by the varying ranged distances.

By way of example, and not to limit the disclosure, an archery hunter is attempting to make a shot on a deer. The hunter uses their rangefinder to obtain multiple distances to the deer. The rangefinder returns two distances, 34 and 36 yards. The multiple distances provide a level of doubt to the hunter and causes them to focus more on the distance than on their aiming of the shot. Due to the doubt the multiple distance readings instilled in the user, the hunter's focus is off so that when they release the arrow it travels just above the deer. This was not caused by an improper shot due to the distance ranged but rather the uncertainty caused by the varying ranged distances.

In both examples discussed above, the different distances ranged would not have caused a missed shot on their own. What caused the missed shots was the loss of concentration by the golfer and hunter due to the different distances displayed by the laser rangefinder. If the golfer or hunter had been provided with a consistent distance to their target, it would have removed that sense of doubt. With the distance doubt removed, the golfer and hunter can concentrate more on making the shot.

Thus, a need exists for systems and methods for providing a consistent range reading to a user.

### SUMMARY

In one embodiment, the disclosure relates to systems and methods for providing consistent information to a user of a rangefinder. In one embodiment, the disclosure relates a method comprising providing or displaying a first set of information to a user of a rangefinder, activating the rangefinder a second time to calculate a second set of information, and providing the first set of information to the user of the rangefinder, provided the second set of information is within set tolerance limits of the first set of information.

In one embodiment, the disclosure relates a method comprising: determining a first set of information using a laser rangefinder, displaying the first set of information to a user of the laser rangefinder; activating the rangefinder a second time to calculate a second set of information, and providing either the first set of information or the second set of information to the user of the rangefinder, wherein the first set of information is provided to the user when the second set of information is within set tolerance limits of the first set of information; and the second set of information is provided to the user when the second set of information is outside the set tolerance limits.

In one embodiment, the disclosure relates to a method comprising: ranging a first distance using a laser rangefinder; displaying the first ranged distance on a display of the laser rangefinder; ranging a second distance using the laser rangefinder; comparing the second distance to the first distance; and displaying either the first distance or the second distance on a display of the laser rangefinder, wherein the first distance is displayed when the second distance is within a set distance tolerance limit, and the second distance is displayed when the second distance is outside the set distance tolerance limits.

In one embodiment, the first distance and second distance are ranged to the same target. In another embodiment, the first distance is ranged to a first target and the second distance is ranged to a second target. In yet another embodiment, the ranging of the first distance and the ranging of the second distance occurs within a set time period.

In one embodiment, the disclosure relates to a method comprising: ranging a first distance using a laser rangefinder; displaying the first ranged distance on a display of the laser rangefinder; ranging a second distance using the laser rangefinder; comparing the second distance to the first distance using a program of the laser rangefinder; and displaying either the first distance or the second distance on a display of the laser rangefinder, wherein the first distance is displayed when the second distance is within a set distance tolerance limit of the first distance, and the second distance is displayed when the second distance is outside the set distance tolerance limits.

In one embodiment, the disclosure relates to a method comprising: ranging a first distance using a laser rangefinder; displaying the first ranged distance on a display of the laser rangefinder; ranging a second distance using the laser rangefinder; using the laser rangefinder to compare the second distance to the first distance; and displaying either the first distance or the second distance on a display of the laser rangefinder, wherein the first distance is displayed when the second distance is within a set distance tolerance limit, and the second distance is displayed when the second distance is outside the set distance tolerance limits.

In one embodiment, the user can set the tolerance limits. In yet another embodiment, the tolerance limits are set by the manufacturer. In one embodiment, the tolerance limits can be adjusted. In yet another embodiment, the tolerance limits cannot be adjusted and are permanently established.

In one embodiment, the disclosure relates to a method comprising: ranging a first distance using a laser rangefinder; displaying the first ranged distance on a display of the laser rangefinder; ranging a second distance using the laser rangefinder within a set time period; comparing the second distance to the first distance; and displaying either the first distance or the second distance on the display of the laser rangefinder, wherein the first distance is displayed when the second distance is within a set distance tolerance limit, and the second distance is displayed when the second distance is outside the set distance tolerance limits.

In one embodiment, the disclosure relates to a method comprising: ranging a first distance using a laser rangefinder; displaying the first ranged distance on a display of the laser rangefinder; ranging a second distance using the laser rangefinder within a set time period; using the laser rangefinder to compare the second distance to the first distance; and displaying either the first distance or the second distance on a display of the laser rangefinder, wherein the first distance is displayed when the second distance is within a set distance tolerance limit, and the second distance is displayed when the second distance is outside the set distance tolerance limits.

In one embodiment, the disclosure relates to a method comprising: ranging a first distance using a laser rangefinder; displaying the first ranged distance on a display of the laser rangefinder; ranging a second distance using the laser rangefinder; comparing the second distance to the first distance; and displaying either the first distance or the second distance on a display of the laser rangefinder, wherein the first distance is displayed when the second distance is within a set distance tolerance limit, and the second distance is displayed when the second distance is outside the set distance tolerance limits.

In yet another embodiment, the disclosure relates to a method comprising: ranging a first distance using a laser rangefinder; ranging a second distance using a laser rangefinder; determining if the second distance is within a distance tolerance limit of the first distance; and displaying either the first distance or the second distance on a display of the laser rangefinder, wherein the first distance is displayed when the second distance is within the tolerance limit of the first distance and the second distance is displayed when the second distance is beyond the tolerance limit of the first distance.

In yet another embodiment, the disclosure relates to a method comprising: ranging a first distance using a laser rangefinder; ranging a second distance using a laser rangefinder; using a program of the laser rangefinder to determine if the second distance is within a distance tolerance limit of the first distance; and displaying either the first distance or the second distance on a display of the laser rangefinder, wherein the first distance is displayed when the second distance is within the tolerance limit of the first distance and the second distance is displayed when the second distance is beyond the tolerance limit of the first distance.

In another embodiment, the disclosure relates to a method comprising: ranging a first distance using a laser rangefinder and determining a first compass heading; ranging a second distance using a laser rangefinder and determining a second compass heading; comparing the second distance to the first distance and the second compass heading to the first compass heading; and displaying the first distance and first compass heading on a display of the laser rangefinder when the second distance is within a distance tolerance limit of the first distance and the second compass heading is within a compass tolerance limit of the first compass heading.

In another embodiment, the disclosure relates to a method comprising: ranging a first distance using a laser rangefinder and determining a first compass heading; ranging a second distance using a laser rangefinder and determining a second compass heading; comparing the second distance to the first distance; comparing the second compass heading to the first compass heading; and displaying either the first distance and first compass heading or the second distance and second compass heading on a display of the laser rangefinder, wherein (i) the first distance and first compass heading are displayed when the second distance is within a set distance tolerance limit of the first distance and the second compass heading is within a set compass heading tolerance limit of the first compass heading; and (ii) the second distance and second compass heading are displayed when second distance is beyond the set distance tolerance limit of the first distance and/or the second compass heading is beyond the set compass heading tolerance limit of the first compass heading.

In another embodiment, the disclosure relates to a method comprising: ranging a first distance using a laser rangefinder and determining a first angle of measurement; ranging a second distance using a laser rangefinder and determining a second angle of measurement; comparing the second distance to the first distance and the second angle of measurement to the first angle of measurement; and displaying the first distance and first angle of measurement on a display of the laser rangefinder, wherein the first distance and second distance are within a distance tolerance limit and the first angle of measurement and second angle of measurement are within a set angle of measurement limit.

In yet another embodiment, the disclosure relates to a method comprising: ranging a first distance using a laser rangefinder and determining a first angle of measurement; ranging a second distance using a laser rangefinder and determining a second angle of measurement; determining if the second distance is within a set distance tolerance limit of the first distance; determining if the second angle of measurement is within a set angle of measurement tolerance limit of the first angle of measurement; displaying either the first distance and first angle of measurement or the second distance and second angle of measurement on a display of the laser rangefinder, wherein (i) the first distance and first angle of measurement is displayed when the second distance is within the distance tolerance limit of the first distance and the second angle of measurement is within the angle of measurement tolerance limit of the first angle of measurement and (ii) the second distance is displayed when either the second distance is beyond the tolerance distance limit of the first distance and/or the second angle of measurement is beyond the angle of measurement tolerance limit of the first angle of measurement.

In another embodiment, the disclosure relates to a method comprising: ranging a first distance using a laser rangefinder and determining a first position using a global positioning system; ranging a second distance using the laser rangefinder and determining a second position using the global positioning system; comparing the second distance to the first distance and the second position to the first position; and displaying the first distance and first position on a display of the laser rangefinder, wherein the first distance and second distance are within a distance tolerance limit and the second position and first position are within a position tolerance limit.

In another embodiment, the disclosure relates to a method comprising: ranging a first distance using a laser rangefinder and determining a first position using a global positioning system; ranging a second distance using the laser rangefinder and determining a second position using the global positioning system; determining if the second distance is within a set distance tolerance limit of the first distance; determining if the second position is within a set position tolerance limit of the first position; displaying either the first distance and first position or the second distance and second position on a display of the laser rangefinder, wherein (i) the first distance and first position is displayed when the second distance is within the distance tolerance limit of the first distance and the second position is within the position tolerance limit of the first position and (ii) the second distance is displayed when either the second distance is beyond the tolerance distance limit of the first distance and/or the second position is beyond the position tolerance limit of the first position.

### DETAILED DESCRIPTION

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

It will be appreciated by those skilled in the art that the set of features and/or capabilities may be readily adapted within the context of a standalone viewing optic, such as a weapons sight, front-mount or rear-mount clip-on weapons sight, and other permutations of field deployed optical weapons sights. Further, it will be appreciated by those skilled in the art that various combinations of features and capabilities may be incorporated into add-on modules for retrofitting existing fixed or variable viewing optics of any variety.

The numerical ranges in this disclosure are approximate, and thus may include values outside of the range unless otherwise indicated. Numerical ranges include all values from and including the lower and the upper values (unless specifically stated otherwise), in increments of one unit, provided that there is a separation of at least two units between any lower value and any higher value. As an example, if a compositional, physical or other property, such as, for example, distance, speed, velocity, etc., is from 10 to 100, it is intended that all individual values, such as 10, 11, 12, etc., and sub ranges, such as 10 to 44, 55 to 70, 97 to 100, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, distances from a user of a device to a target.

Spatial terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of device in use or operation in addition to the orientation depicted in the figures. For example, if the device is turned over, elements described as “below” or “beneath” other elements or features would then be orientated “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the term “and/or” includes any and all combinations of one or more of the associated listed terms. For example, when used in a phrase such as “A and/or B,” the phrase “and/or” is intended to include both A and B; A or B; A (alone); and B (alone). Likewise, the term “and/or” as used in a phrase such as “A, B and/or C” is intended to encompass each of the following embodiments: A, B and C; A, B, or C; A or C; A or B; B or C; A and C; A and B; B and C; A (alone); B (alone); and C (alone).

It will be understood that when an element or layer is referred to as being “on,” “connected to,” or “coupled to” another element or layer, it can be directly on, connected to or coupled to the other element or layer. Alternatively, intervening elements or layers may be present. In contrast, when an element or layer is referred to as being “directly on,” “directly connected to,” or “directly coupled to” another element or layer, there are no intervening elements or layers present.

As used herein, the term “electronic device” may include, but is not limited to, smartphones, tablet PCs, mobile phones, video phones, e-book readers, desktop PCs (personal computers), laptop computers, netbook computers, PDAs (personal digital assistants), PMPs (portable multimedia players), MP3 players, mobile medical devices, cameras, or wearable devices (e.g., head-mounted devices (HMDs), electronic clothes, electronic bracelets, electronic necklaces, electronic appcessories, electronic tattoos, or smart watches).

As used herein, the terms “user” or “shooter” interchangeably refer to either the operator making the shot or an individual observing the shot in collaboration with the operator making the shot.

It should be understood that when the term “other hunter” is used herein, it refers here to a secondary hunter, a person participating in hunting or walking through hunting grounds, or even hunting dogs themselves.

As used herein, the term “viewing optic” refers to an apparatus or assembly used by a user, a shooter or a spotter to select, identify and/or monitor a target. A viewing optic may rely on visual observation of the target or, for example, on infrared (IR), ultraviolet (UV), radar, thermal, microwave, magnetic imaging, radiation including X-ray, gamma ray, isotope and particle radiation, night vision, vibrational receptors including ultra-sound, sound pulse, sonar, seismic vibration, magnetic resonance, gravitational receptors, broadcast frequencies including radio wave, television and cellular receptors, or other image of the target. The image of the target presented to a user/shooter/spotter by a viewing optic may be unaltered, or it may be enhanced, for example, by magnification, amplification, subtraction, superimposition, filtration, stabilization, template matching, or other means. The target selected, identified and/or monitored by a viewing optic may be within the line of sight of the shooter or tangential to the sight of the shooter. In other embodiments, the shooter's line of sight may be obstructed while the viewing optic presents a focused image of the target. The image of the target acquired by the viewing optic may, for example, be analog or digital, and shared, stored, archived or transmitted within a network of one or more shooters and spotters by, for example, video, physical cable or wire, IR, radio wave, cellular connections, laser pulse, optical 802.1 lb or other wireless transmission using, for example, protocols such as html. SML, SOAP, X.25, SNA, etc., Bluetooth™, Serial, USB or other suitable image distribution method. The term “viewing optic” is used interchangeably with “optic sight.”

As used herein, a “firearm” is a portable gun, being a barreled weapon that launches one or more projectiles often driven by the action of an explosive force. As used herein, the term “firearm” includes a handgun, a long gun, a rifle, a shotgun, a carbine, automatic weapons, semi-automatic weapons, a machine gun, a sub-machine gun, an automatic rifle and an assault rifle.

As used herein, the term “outward scene” refers to a real world scene, including but not limited to a target.

As used herein, the term “tolerance limit” refers to an upper and lower threshold set by a user and/or by a manufacture of a device. In one non-limiting embodiment, a tolerance limit can be set in distance, such as yards or meters. In another non-limiting embodiment, a tolerance limit can be set in angels of measurement, a compass heading, or a position determined by a global positioning system. In one embodiment, a tolerance limit can be within one unit of measurement or as much as 50 units of measurement. By way of example and not to limit the disclosure, for a second ranged distance to be within the tolerance limits of ±3 yards of a first ranged distance, the second ranged distance cannot be less than 3 yards or more than 3 yards of the first ranged distance. By way of example, a first ranged distance is 50 yards, and the tolerance limit is ±3 yards (47 to 53 yards). A second ranged distance of 52 yards is within the set tolerance limits. By way of example, a first ranged distance is 50 yards and the tolerance limit is ±3 yards (47 to 53 yards). A second ranged distance of 45 yards is outside or beyond the set tolerance limits.

In one embodiment, the disclosure relates to systems and methods for providing information to a user of a rangefinder. In one embodiment, the disclosure relates to systems and methods for providing consistent information to a user of a rangefinder. In one embodiment, the disclosure relates a method comprising providing a first set of information to a user of a rangefinder, activating the rangefinder a second time to calculate a second set of information, and providing the first set of information to the user of the rangefinder, provided the second set of information is within set tolerance limits of the first set of information.

In another embodiment, the disclosure relates a method comprising providing a first set of information to a user of a rangefinder; providing a second set of information to the user of a rangefinder; using the rangefinder to compare the first set of information to the second set of information; and providing the first set of information to the user of the rangefinder when the second set of information is within set tolerance limits of the first set of information.

In a representative, non-limiting manner, a ranging system uses a laser beam to determine the distance to an object or to a target, and operates by sending a laser pulse towards target and measuring the time taken by the pulse to be reflected off the target and returned. A laser pulse is emitted from a transmitter, such as a pulse laser diode. Part of the beam emitted travels through a beam splitter, and part is reflected to detector. The emitted laser pulse travels through a transmission lens to target, which reflects a portion of the laser pulse back through receiving lens and subsequently through receiver to a micro-controller unit which calculates the distance to target using well known mathematical principles. Ranging system could also be a more complex system with additional or alternative components, including gain control components, charging capacitors, and analog to digital converters by way of example.

In one embodiment, the disclosure relates to a method comprising determining a first range to a target using a laser rangefinder and displaying the first range to a user of the laser rangefinder; determining a second range to the target using the laser rangefinder; comparing the first range to second range; and displaying the first range to the user of the laser rangefinder, provided the first range and second range are within tolerance limits. In one embodiment, a tolerance limit includes but is not limited to ±1 yard, ±2 yard, ±3 yards, ±4 yards, ±5 yards, ±6 yards, ±7 yards, ±8 yards, ±9 yards, and ±10 yards. In one embodiment, a tolerance limit is less than ±2 yards, less than ±3 yards or less than ±4 yards or less than ±5 yards. In one embodiment, a tolerance limit is no more than ±2 yards, no more than ±3 yards, no more than ±4 yards, and no more than ±5 yards.

In one embodiment, a tolerance limit is from ±1-4 yards, or from ±1-3 yards, or from ±1-2 yards.

In one embodiment, the laser rangefinder has as at least two sets of distance tolerance limits. In one embodiment, the laser rangefinder has a first set of distance tolerance limits of ±3 yards and a second set of distance tolerance limits of ±5 yards.

In one embodiment, the laser rangefinder has a first set of distance tolerance limits of ±1 yard and a second set of distance tolerance limits of ±3 yards.

In one embodiment, the laser rangefinder has a first set of distance tolerance limits of ±1 yard and a second set of distance tolerance limits of ±5 yards.

In one embodiment, the disclosure relates to a method comprising determining a first range to a target using a laser rangefinder and displaying the first range to a user of the laser rangefinder; determining a second range to the target using the laser rangefinder; comparing the first range to the second range; and displaying either the first range or the second range to the user of the laser rangefinder, wherein the first range is displayed when the second range is within a selected tolerance limit of the first range and the second range is displayed when the second range is outside or beyond the selected tolerance limit of the first range.

In one embodiment, the disclosure relates to a method comprising determining a first range to a target using a laser rangefinder and displaying the first range to a user of the laser rangefinder; determining a second range to the target using the laser rangefinder; comparing the first range to the second range; and displaying the first range to the user of the laser rangefinder when the first range and second range are within a selected tolerance limit.

The methods disclosed herein remove the sense of doubt that occurs when a first range and a second range differ and allows the user to concentrate on factors other than the variability in the determined range. In one embodiment, if a subsequent(s) distance is received by the rangefinder and is within a selected tolerance limit as compared to a previous distance, the rangefinder will continue to display the previous distance. By displaying a consistent distance, the user can focus on all the other aspects of the shot to allow for a greater probability of making the shot.

In one embodiment, the systems and methods disclosed herein may use time, distance, angle, direction, user position or any combination of features to assist with a tolerance limit for the displayed distance. In one embodiment, time can either be set by the user or fixed by the manufacturer. In one embodiment, a second distance ranged within a set time period would be compared to a first ranged distance. If the second distance was within a tolerance limit of the first ranged distance and within a set time period, the first ranged distance would be displayed.

In one embodiment, the set time period is 5 seconds, or 10 seconds, or 15 seconds, or 20 seconds, or 30 seconds, or 40 seconds, or 50 seconds, or 55 seconds, or 60 seconds or greater than 60 seconds.

In one embodiment, the set time period is at least 5 seconds or at least 20 seconds or at least 30 seconds or at least 45 seconds or at least 60 seconds.

In one embodiment, the set time period is from 5 seconds to 90 seconds, or from 10 seconds to 80 seconds, or from 15 seconds to 70 seconds, or from 20 seconds to 60 seconds, or from 25 seconds to 50 seconds, or from 30 seconds to 40 seconds.

In one embodiment, the set time period is less than 1 minute, less than 2 minutes, less than 3 minutes, less than 4 minutes, less than 5 minutes, less than 10 minutes, less than 15 minutes, or less than 30 minutes.

In one embodiment, the set time period is selected from the group consisting of 5, 10, 15, 20, 25, 30, 35, 40, 45, 50, 55, 60, 65, and greater than 65 seconds.

By way of example and not to limit the disclosure, an archery hunter is attempting to make a shot at a target, such as a deer. The hunter uses a rangefinder to obtain multiple distances to the deer. The first distance received is 32 yards and 32 yards is displayed to the hunter. The receipt of the first distance starts a timer and any distance received within a specified time is compared to the first distance. The second ranged distance is 33 yards; the second ranged distance is compared to the first ranged distance. Since the tolerance distance is set at ±2 yards (30 yards to 34 yards) and the second distance is received within the set time of 15 seconds, the displayed distance will be the first ranged distance of 32 yards.

By way of example and not to limit the disclosure, an archery hunter is attempting to make a shot at a target, such as a deer. The hunter uses a rangefinder to obtain multiple distances to the deer. The first distance received is 32 yards and 32 yards is displayed to the hunter. The receipt of the first distance starts a timer and any distance received within a specified time is compared to the first distance. The second ranged distance is 40 yards; the second ranged distance is compared to the first ranged distance. The tolerance distance is set at ±2 yards and the second distance was received within the set time of 15 seconds. However, the second ranged distance (40 yards) is greater than the tolerance limit of +2 yards (30 yards to 34 yards), therefore the displayed distance will be the second ranged distance of 40 yards.

In another embodiment, distance, angular, and direction tolerance can also either be set by the user or fixed by the manufacturer. The systems and methods disclosed herein applies to the multiple and numerous ways to obtain distance, angular, directional, and positional data.

By way of example and not to limit the disclosure, a golfer is attempting to take a shot at a green. The golfer uses a rangefinder to obtain multiple distances to the pin. The first ranged distance received is 83 yards and 83 yards is displayed to the golfer. The receipt of the first distance starts a set timer of 10 seconds, wherein any distance received within 10 seconds is compared to the first ranged distance. The second ranged distance received is 85 yards and is compared to the first ranged distance. Since the tolerance distance was set at ±3 yards (80 yards to 86 yards) and the second ranged distance was received within the set time of 10 seconds, the displayed distance will be the first ranged distance and remain at 84 yards. The third distance received is 82 yards and is compared to the first distance. Since the tolerance distance was set at ±3 yards (80 yards to 86 yards) and the third distance was received within the set time of 10 seconds, the displayed distance will be the first ranged distance and remain at 84 yards.

By way of example and not to limit the disclosure, a shooter is attempting to take a shot at a steel target. The shooter uses a rangefinder to obtain multiple distances to the target. The first ranged distance is 299 yards and 299 yards is displayed to the shooter. The receipt of the first distance starts a set timer for 15 seconds, wherein any distance received within the set time period is compared to the first ranged distance. The second ranged is 301 yards and is compared to the first ranged distance. Since the tolerance distance was set at ±2 yards (297 yards to 301 yards) and the second distance was received within the set time of 15 seconds, the displayed distance will be the first ranged distance and remain at 299 yards.

By way of example and not to limit the disclosure, a golfer is attempting to take a shot at a fairway. The golfer uses a rangefinder to obtain multiple distances to assist in club selection and shot placement. The first ranged distance received is 245 yards to a tree, and 245 yards is displayed to the golfer. The receipt of the first distance starts a set timer of 10 seconds, wherein any distance received within a specified time is compared to the first ranged distance. The second ranged distance received is 223 yards representing the distance from the golfer to the middle of the fairway, and is compared to the first ranged distance of 245 yards. Since the tolerance distance was set at ±3 yards (242 yards to 248 yards) and the second ranged distance is outside the set tolerance limits, the displayed distance will be the second ranged distance of 223 yards. In this embodiment, the second distance of 223 yards now becomes the distance to which subsequent ranges of distance will be compared. The third ranged distance received is 225 yards representing the distance from the golfer to the middle of the fairway, and is compared to the second ranged distance of 223 yards. Since the tolerance distance was set at ±3 yards (220 yards to 226 yards) and the third ranged distance was received within the set time of 10 seconds, the displayed distance will remain the second range distance of 223 yards.

By way of example and not to limit the disclosure, a hunter is attempting to take a rifle shot at an elk. The hunter uses a rangefinder to obtain multiple distances to the elk. The rangefinder has a set timer of 10 seconds, a distance tolerance limit of ±3 yards, and a compass reading tolerance limit of ±5°. The first ranged distance received is 174 yards, with a first compass heading of 275°. The 174 yards ranged distance is displayed to the hunter. The receipt of the first ranged distance starts a set timer of 10 seconds, wherein any distance received within a specified time is compared to the first ranged distance and compass heading. The second distance received is 173 yards with a compass heading of 272° and is compared to the first ranged distance and the first compass heading. The distance tolerance was set at ±3 yards (171 yards to 177 yards), and the compass reading tolerance was set at ±5° (270° to 280°). The second ranged distance the second compass heading are within the set tolerance limits, the distance and compass reading displayed corresponds to the first ranged distance ranged of 174 yards the first compass heading of 275°.

By way of example and not to limit the disclosure, a golfer is attempting to take a shot to avoid a bunker. The golfer uses a rangefinder to obtain a first distance to the far side of the bunker. The first ranged distance is 204 yards and 204 yards is displayed to the golfer. The receipt of the first ranged distance starts a set timer of 10 seconds, wherein any distance received within a specified time is compared to the first ranged distance. The second ranged distance is for the near side of the bunker, and the second ranged distance is 197 yards. The laser rangefinder compares the second ranged distance to the first ranged distance. Since the tolerance distance was set at ±3 yards (201 yards to 207 yards), and the second ranged distance is outside the set tolerance limits, the displayed distance corresponds to the second ranged distance of 197 yards.

By way of example and not to limit the disclosure, an archery hunter is attempting to make a shot on a deer. The hunter uses a rangefinder to obtain distances to two different deer. The rangefinder has a set timer of 10 seconds, a tolerance distance of ±2 yards, and a tolerance angle of ±5°. The first ranged distance is 36 yards at a first angle of 32°, which corresponds to the first deer, and 36 yards at an angle of 32° is displayed to the hunter. The receipt of the first distance starts the set timer of 10 seconds, wherein any distance and angle received within 10 seconds is compared to the first distance and angle. The second ranged distance is 34 yards at a second angle of 24°, which corresponds to the second deer, and is compared to the first ranged distance and first determined angle. The tolerance distance was set at ±2 yards (34 yards to 38 yards), and the tolerance angle was set to ±5° (27° to 37°). The second ranged distance is within the set tolerance limits but the second angle is outside the set tolerance limit. Thus, the displayed distance and angle will correspond to the second distance of 34 yards and second angle of 24°.

By way of example and not to limit the disclosure, a golfer is attempting to take a shot to get back on the fairway. The golfer uses a rangefinder to obtain a distance to the fairway. The rangefinder has a set timer of 8 seconds, a tolerance distance of ±2 yards, and a GPS tolerance distance set at ±3 feet. The first ranged distance is 98 yards, and a first position is obtained from the onboard GPS. The receipt of the first distance starts a set timer, wherein any distance received within a specified time is compared to the first distance and GPS position. The second ranged distance is 97 yards, and the second GPS position is 2 feet to the left of the original position. The second distance and second GPS position is compared to the first distance and first GPS position. The tolerance distance was set at ±2 yards (96 yards to 100 yards), the GPS tolerance distance was set at ±3 feet. Since the second ranged distance and second GPS position are within the set tolerance limits, the displayed distance and GPS position remains the first ranged distance of 98 yards and first GPS position.

By way of example and not to limit the disclosure, a hunter is attempting to obtain the distance to a tree line. The hunter uses a rangefinder to obtain a distance to the tree line. The rangefinder has a set time of 10 seconds, a tolerance distance set at ±3 yards, a tolerance angle set at ±5°, and a tolerance heading set a ±10°. The first ranged distance is 422 yards at a first angle of 6° with a first heading of 47° and all of this is displayed to the user. The receipt of the first ranged distance starts a set timer of 10 seconds, wherein any distances, angles, and headings received within the specified time is compared to the first distance, first angle, and first heading. The second distance to the tree line received is 426 yards at a second angle of 5° with a second heading of 45° and is compared to the first distance, first angle, and first heading. The tolerance distance was set at ±3 yards (419 to 425), tolerance angle set at ±5° (1° to 11°), tolerance heading set a ±10° (0° to 20°) . Since the second ranged distance is outside the set tolerance limits, the second ranged distance, second angle and second heading will be displayed to the user.

In a representative implementation of a laser-based rangefinding instrument in accordance with the principles of the disclosure, the exterior housing may comprise a polished metal surface similar to that of golf club heads in conjunction with golf grip type material to enable an improved, more secure grip on the unit. A carrying case of material and design similar to that of golf club head covers may also accompany the instrument.

In one embodiment, the disclosure relates to a program for comparing a first ranged distance to a second ranged distance.

In another embodiment, the disclosure relates to a program for comparing a first GPS position to a second GPS position.

In another embodiment, the disclosure relates to a program for comparing a first angle to a second angle.

In another embodiment, the disclosure relates to a program for comparing a first heading to a second heading.

In one embodiment, the disclosure relates to a laser rangefinder configured to compare a first ranged distance to a second ranged distance.

In another embodiment, the disclosure relates to a laser rangefinder configured to compare first GPS position to a second GPS position.

In another embodiment, the disclosure relates to a laser rangefinder configured to compare a first angle to a second angle.

In another embodiment, the disclosure relates to a laser rangefinder configured to compare a first heading to a second heading.

In one embodiment, the disclosure relates to a laser rangefinder. In one embodiment, the laser rangefinder can be programmed for one or more tolerance limits. In one embodiment, the tolerance limits can be determined based on the application of use of the laser rangefinder. In one embodiment, the laser rangefinder may have a first set of tolerance limits for hunting and a second set of tolerance limits for golfing. In one embodiment, the laser rangefinder can have more than one set of tolerance limits. In one embodiment, the tolerance limits can be selected by the user. In one embodiment, the tolerance limits are selected by the manufacturer of the laser rangefinder.

In one embodiment, the laser rangefinder is configured to compare a first ranged distance to a second ranged distance. In another embodiment, the laser rangefinder is configured to display either the first distance or the second distance on the display of the laser rangefinder, wherein the first distance is displayed when the second distance is within set tolerance limits of the first distance and the second distance is displayed when the second distance is outside of the set tolerance limits.

In another embodiment, the laser rangefinder is configured to compare a first ranged distance to a second ranged distance; and compare a first compass heading to a second compass heading; and displaying either the first distance and first compass heading or the second distance and second compass heading on the display of the laser rangefinder, wherein (i) the first distance and first compass heading are displayed when the second distance is within a set distance tolerance limit of the first distance and the second compass heading is within a set compass heading tolerance limit of the first compass heading; and (ii) the second distance and second compass heading are displayed when the second distance is beyond the set distance tolerance limit of the first distance and/or the second compass heading is beyond the set compass heading tolerance limit of the first compass heading.

In another embodiment, the laser rangefinder is configured to compare a first ranged distance to a second ranged distance; and compare a first angle of measurement to a second angle of measurement; and displaying either the first distance and first angle of measurement or the second distance and second angle of measurement on the display of the laser rangefinder, wherein (i) the first distance and first angle of measurement are displayed when the second distance is within a set distance tolerance limit of the first distance and the second angle of measurement is within a set angle of measurement tolerance limit of the first angle of measurement; and (ii) the second distance and second angle of measurement are displayed when the second distance is beyond the set distance tolerance limit of the first distance and/or the second angle of measurement is beyond the set angle of measurement tolerance limit.

In another embodiment, the laser rangefinder is configured to compare a first ranged distance to a second ranged distance; and compare a first GPS position to a second a GPS position; and displaying either the first distance and first GPS position or the second distance and second GPS position on the display of the laser rangefinder, wherein (i) the first distance and first GPS position are displayed when the second distance is within a set distance tolerance limit of the first distance and the second GPS position is within a set GPS position tolerance limit of the first GPS position; and (ii) the second distance and second GPS position are displayed when the second distance is beyond the set distance tolerance limit of the first distance and/or the second GPS position is beyond the set GPS position tolerance limit.

In one embodiment, the laser rangefinder is configured to range a first distance, display the first ranged distance on a display, range a second distance, compare the first distance to the second distance using the laser rangefinder; and display either the first distance or the second distance on the display, wherein the first distance is displayed when the second distance is within set tolerance limits of the first distance and the second distance is displayed when the second distance is outside of the set tolerance limits.

In one embodiment, the laser rangefinder is configured to range a first distance and determine a first compass heading, display the first ranged distance and first compass heading on a display, range a second distance and determine a second compass heading, compare the second distance to the first distance, compare the second compass heading to the first compass heading; and display either the first distance and first compass heading or the second distance and second compass heading on the display of the laser rangefinder, wherein (i) the first distance and first compass heading are displayed when the second distance is within a set distance tolerance limit of the first distance and the second compass heading is within a set compass heading tolerance limit of the first compass heading; and (ii) the second distance and second compass heading are displayed when the second distance is beyond the set distance tolerance limit of the first distance and/or the second compass heading is beyond the set compass heading tolerance limit of the first compass heading.

In one embodiment, the laser rangefinder is configured to range a first distance using a laser rangefinder and determine a first angle of measurement, display the first ranged distance and the first angle of measurement on a display, range a second distance using the laser rangefinder and determine a second angle of measurement, determine if the second distance is within a set distance tolerance limit of the first distance; determine if the second angle of measurement is within a set angle of measurement tolerance limit of the first angle of measurement; and display either the first distance and first angle of measurement or the second distance and second angle of measurement on the display of the laser rangefinder, wherein (i) the first distance and first angle of measurement is displayed when the second distance is within the set distance tolerance limit of the first distance and the second angle of measurement is within the set angle of measurement tolerance limit of the first angle of measurement and (ii) the second distance is displayed when the second distance is beyond the set distance tolerance limit of the first distance and/or the second angle of measurement is beyond the set angle of measurement tolerance limit of the first angle of measurement.

While various embodiments of the sighting device have been described in detail, it should be apparent that modifications and variations thereto are possible, all of which fall within the true spirit and scope of the invention. With respect to the above description then, it is to be realized that the optimum dimensional relationships for the parts of the disclosed technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1 A method comprising:
(a) ranging a first distance using a laser rangefinder;
(b) displaying the first ranged distance on a display of the laser rangefinder;
(c) ranging a second distance using the laser rangefinder;
(d) comparing the first distance to the second distance using the laser rangefinder; and
(e) displaying either the first distance or the second distance on the display of the laser rangefinder, wherein the first distance is displayed when the second distance is within set tolerance limits of the first distance and the second distance is displayed when the second distance is outside of the set tolerance limits.

2. The method of claim 1, wherein the first distance and second distance are ranged to the same target.

3. The method of claim 1, wherein the first distance is ranged to a first target and the second distance is ranged to a second target.

4. The method of claim 1, wherein ranging the first distance and ranging the second distance occurs within a set time period.

5. The method of claim 4, wherein the set time period is selected from the group consisting of 5, 10, 15, 20, 25, 30, 35, 40, 45, 50, 55, 60, 65, and greater than 65 seconds.

6. The method of claim 4, wherein the set time period is less than 60 seconds.

7. The method of claim 1, wherein the set distance tolerance limit is selected from the group consisting of: ±1 yard, ±2 yards, ±3 yards, ±4 yards, ±5 yards, ±6 yards, ±7 yards, ±8 yards, ±9 yards, and ±10 yards.

8. The method of claim 1, wherein the set distance tolerance limit is ±3 yards.

9. A method comprising:
(a) ranging a first distance using a laser rangefinder and determining a first compass heading;
(b) displaying the first ranged distance and first compass heading on a display of the laser rangefinder;
(c) ranging a second distance using the laser rangefinder and determining a second compass heading;
(d) comparing the second distance to the first distance;
(e) comparing the second compass heading to the first compass heading; and
(f) displaying either the first distance and first compass heading or the second distance and second compass heading on the display of the laser rangefinder, wherein
(i) the first distance and first compass heading are displayed when the second distance is within a set distance tolerance limit of the first distance and the second compass heading is within a set compass heading tolerance limit of the first compass heading; and
(ii) the second distance and second compass heading are displayed when the second distance is beyond the set distance tolerance limit of the first distance and/or the second compass heading is beyond the set compass heading tolerance limit of the first compass heading.

10. The method of claim 9, wherein the first distance and second distance are ranged to the same target.

11. The method of claim 9, wherein the first distance is ranged to a first target and the second distance is ranged to a second target.

12. The method of claim 9, wherein ranging the first distance and ranging the second distance occurs within a set time period.

13. The method of claim 12, wherein the set time period is selected from the group consisting of 5, 10, 15, 20, 25, 30, 35, 40, 45, 50, 55, 60, 65, and greater than 65 seconds.

14. The method of claim 12, wherein the set time period is less than 60 seconds.

15. The method of claim 9, wherein the set distance tolerance limit is selected from the group consisting of: ±1 yard, ±2 yards, ±3 yards, ±4 yards, ±5 yards, ±6 yards, ±7 yards, ±8 yards, ±9 yards, and ±10 yards.

16. The method of claim 9, wherein the set distance tolerance limit is ±3 yards.

17. A method comprising:
(a) ranging a first distance using a laser rangefinder and determining a first angle of measurement;
(b) displaying the first ranged distance and the first angle of measurement on a display of the laser rangefinder;
(b) ranging a second distance using the laser rangefinder and determining a second angle of measurement;
(c) determining if the second distance is within a set distance tolerance limit of the first distance;
(d) determining if the second angle of measurement is within a set angle of measurement tolerance limit of the first angle of measurement; and
(e) displaying either the first distance and first angle of measurement or the second distance and second angle of measurement on the display of the laser rangefinder, wherein
(i) the first distance and first angle of measurement is displayed when the second distance is within the set distance tolerance limit of the first distance and the second angle of measurement is within the set angle of measurement tolerance limit of the first angle of measurement and
(ii) the second distance is displayed when the second distance is beyond the set distance tolerance limit of the first distance and/or the second angle of measurement is beyond the set angle of measurement tolerance limit of the first angle of measurement.

18. The method of claim 17, wherein the first distance and second distance are ranged to the same target.

19. The method of claim 17, wherein the first distance is ranged to a first target and the second distance is ranged to a second target.

20. The method of claim 17, wherein ranging the first distance and the ranging the second distance occurs within a set time period.
